(19) United States
(12) Patent Application Publication
(10) Pub. No.: US 2015/0373602 A1
(43) Pub. Date: Dec. 24, 2015

(54) PREEMPTIVE MOBILE HANDOVER PREPARATION

(71) Applicant: QUALCOMM Incorporated, San Diego, CA (US)

(72) Inventors: Karl Georg Hampel, New York, NY (US); Ashwin Sampath, Skillman, NJ (US)

(21) Appl. No.: 14/599,280

(22) Filed: Jan. 16, 2015

Related U.S. Application Data
(60) Provisional application No. 62/013,948, filed on Jun. 18, 2014.

(51) Int. Cl. H04W 36/08; H04W 36/00

(52) U.S. Cl. CPC H04W 36/08; H04W 36/0083

(57) ABSTRACT

Apparatuses and methods for performing preemptive mobile handover preparation are provided. One such method of wireless communication for a wireless communication device includes receiving a first radio resource control (RRC) handover preparation message including information sufficient to enable a handover to each of a plurality of preselected target cells, storing the handover information for each of the plurality of preselected target cells, selecting, at the wireless communication device, a first preselected target cell from the plurality of preselected target cells, performing a handover to the first preselected target cell of the plurality of preselected target cells, and sending an RRC connection reconfiguration complete message to the first preselected target cell.

### PRIORITY CLAIM

This application claims priority to and the benefit of U.S. Provisional Application No. 62/013,948, Attorney Docket No. QCOM-2622P1 (144631P1), filed Jun. 18, 2014, the entire contents of which are incorporated herein by reference as if fully set forth below and for all applicable purposes.

### TECHNICAL FIELD

Aspects of the present disclosure relate generally to wireless communication systems, and more particularly, to preemptive mobile handover preparation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. One example of a telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

In present LTE, intra-RAT (Radio Access Technology) handover decisions are generally made by the network while the mobile node (UE) assists the handover decision by providing signal strength measurements of potential target cells. An exception occurs when the UE's radio link to the serving cell fails before it has received the Radio Resource Control (RRC) connection reconfiguration message from the serving cell. Under such circumstances, the UE undergoes the Radio Link Failure (RLF) recovery procedure where it accesses a potential target cell using a contention based random access channel (RACH). However, the time frame for this RLF recovery procedure is much larger than for a conventional handover creating significant disruption to higher protocol layers. Further, the evolution toward smaller cell sizes and higher frequency bands such as millimeter waves (mmWaves) make handover via RLF recovery a procedure that is increasingly more likely. Therefore, a method and apparatus is sought that permits faster execution of handover, and more specifically, handover associated with the RLF recovery procedure.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or elements of all aspects of the disclosure nor to delineate the scope of any or all aspects of the disclosure. Its sole purpose is to present some concepts of one or more aspects of the disclosure in a simplified form as a prelude to the more detailed description that is presented later.

One or more aspects of the present disclosure provide for preemptive mobile handover preparation. For example, in one aspect, a source cell preemptively prepares a mobile device for a handover to multiple target cells and the mobile device later selects one of the target cells for the handover. In such case, the handover process can be much more efficient, and more specifically, in the case of Radio Link Failure (RLF), the handover process can be much shorter to recover from the RLF as the mobile device has been prepared with the information of multiple potential target cells.

One such aspect involves a method of wireless communication for a wireless communication device, including receiving a first radio resource control (RRC) handover preparation message including information sufficient to enable a handover to each of a plurality of preselected target cells, storing the handover information for each of the plurality of preselected target cells, selecting, at the wireless communication device, a first preselected target cell from the plurality of preselected target cells, performing a handover to the first preselected target cell of the plurality of preselected target cells, and sending an RRC connection reconfiguration complete message to the first preselected target cell.

Another aspect involves a wireless communication device including means for receiving a first radio resource control (RRC) handover preparation message including information sufficient to enable a handover to each of a plurality of preselected target cells, means for storing the handover information for each of the plurality of preselected target cells, means for selecting, at the wireless communication device, a first preselected target cell from the plurality of preselected target cells, means for performing a handover to the first preselected target cell of the plurality of preselected target cells, and means for sending an RRC connection reconfiguration complete message to the first preselected target cell.

Another aspect involves a wireless communication device including at least one processor, a memory communicatively coupled to the at least one processor, and a communication interface communicatively coupled to the at least one processor, where the at least one processor is configured to receive a first radio resource control (RRC) handover preparation message including information sufficient to enable a handover to each of a plurality of preselected target cells, store the handover information for each of the plurality of preselected target cells, select, at the wireless communication device, a first preselected target cell from the plurality of preselected target cells, perform a handover to the first preselected target cell of the plurality of preselected target cells, and send an RRC connection reconfiguration complete message to the first preselected target cell.

Another aspect involves a non-transitory computer readable medium storing computer executable code, including code for receiving a first radio resource control (RRC) handover preparation message including information sufficient to enable a handover to each of a plurality of preselected target cells, storing the handover information for each of the plurality of preselected target cells, selecting, at a wireless communication device, a first preselected target cell from the plurality of preselected target cells, performing a handover to the first preselected target cell of the plurality of preselected target cells, and sending an RRC connection reconfiguration complete message to the first preselected target cell.

Yet another aspect involves a method of wireless communication, including receiving a measurement report including measurements for a plurality of target cells from a wireless communication device, sending a handover request message to each of a plurality of preselected target cells of the plurality of target cells, receiving a handover request acknowledgement message from each of the plurality of preselected target cells, including information sufficient to enable a handover to one of the plurality of preselected target cells, and sending a radio resource control (RRC) handover preparation message to the wireless communication device, including handover information for each of the plurality of preselected target cells.

Yet another aspect involves a wireless communication device, including means for receiving a measurement report including measurements for a plurality of target cells from a second wireless communication device, means for sending a handover request message to each of a plurality of preselected target cells of the plurality of target cells, means for receiving a handover request acknowledgement message from each of the plurality of preselected target cells, including information sufficient to enable a handover to one of the plurality of preselected target cells, and means for sending a radio resource control (RRC) handover preparation message to the second wireless communication device, including handover information for each of the plurality of preselected target cells.

Yet another aspect involves a wireless communication device including at least one processor, a memory communicatively coupled to the at least one processor, and a communication interface communicatively coupled to the at least one processor, where the at least one processor is configured to receive a measurement report including measurements for a plurality of target cells from a second wireless communication device, send a handover request message to each of a plurality of preselected target cells of the plurality of target cells, receive a handover request acknowledgement message from each of the plurality of preselected target cells, including information sufficient to enable a handover to one of the plurality of preselected target cells, and send a radio resource control (RRC) handover preparation message to the second wireless communication device, including handover information for each of the plurality of preselected target cells.

Yet another aspect involves a non-transitory computer readable medium storing computer executable code, including code for receiving a measurement report including measurements for a plurality of target cells from a wireless communication device, sending a handover request message to each of a plurality of preselected target cells of the plurality of target cells, receiving a handover request acknowledgement message from each of the plurality of preselected target cells, including information sufficient to enable a handover to one of the plurality of preselected target cells, and sending a radio resource control (RRC) handover preparation message to the wireless communication device, including handover information for each of the plurality of preselected target cells.

These and other aspects of the method and apparatus will become more fully understood upon a review of the detailed description, which follows. Other aspects, features, and embodiments of the present method and apparatus will become apparent to those of ordinary skill in the art, upon reviewing the following description of specific, exemplary embodiments of the present method and apparatus in conjunction with the accompanying figures. While features of the present method and apparatus may be discussed relative to certain embodiments and figures below, all embodiments of the present method and apparatus can include one or more of the advantageous features discussed herein. In other words, while one or more embodiments may be discussed as having certain advantageous features, one or more of such features may also be used in accordance with the various embodiments of the method and apparatus discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a hardware implementation for an apparatus employing a processing system.

FIG. 2 is a diagram illustrating an example of a network architecture.

FIG. 3 is a diagram illustrating an example of an access network.

FIG. 4 is a diagram illustrating an example of a typical handover in a cellular system.

FIGS. 5a and 5b are protocol flow diagrams illustrating typical handover procedures in an LTE system.

FIGS. 6a and 6b are protocol flow diagrams illustrating alternative handover procedures in an LTE system.

FIGS. 7a and 7b are protocol flow diagrams illustrating exemplary handover procedures with preemptive preparation and mobile target selection in an LTE system in accordance with some aspects of the disclosure.

FIG. 8 is a flow chart illustrating an exemplary process for operating a mobile device involved in a handover procedure with preemptive preparation and mobile target selection in accordance with some aspects of the disclosure.

FIG. 9 is a diagram illustrating a simplified example of a hardware implementation for an apparatus employing a processing circuit and adapted for operating a mobile device involved in a handover procedure with preemptive preparation and mobile target selection in accordance with some aspects of the disclosure.

FIG. 10 is a flow chart illustrating an exemplary process for operating a source cell involved in a handover procedure with preemptive preparation and mobile target selection in accordance with some aspects of the disclosure.

FIG. 11 is a diagram illustrating a simplified example of a hardware implementation for an apparatus employing a processing circuit and adapted for operating a source cell involved in a handover procedure with preemptive preparation and mobile target selection in accordance with some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

One or more aspects of the present disclosure provide for a source cell to preemptively prepare a mobile device for a handover to one of multiple target cells and for the mobile device to select one of the target cells for the handover. In such case, the handover process can be much more efficient, and more specifically, in the case of Radio Link Failure (RLF), the handover process can be much shorter to recover from the RLF as the mobile device has been prepared with the information of multiple potential target cells.

More specifically, in one or more aspects, it is proposed that the source cell preemptively prepares the mobile node with all of the data needed to access a potential target cell and allows the mobile device to select one of the target cells for the handover. The term “preemptive” in this context can indicate that the data transfer of the handover information is executed before a handover is imminent. For the purpose of preemptive preparation, the source can send a new message, an RRC handover preparation message, to the mobile. This message can contain the same target cell data as LTE's present RRC connection reconfiguration message. However, as contrasted with LTE's present RRC connection reconfiguration message, the RRC handover preparation message can include an implicit or explicit indication for the mobile to hold back with handover execution until an explicit handover command is given by the source cell in a separate message or until the mobile has detected RLF to the source. The mobile can cache the information included in the RRC handover preparation message so that it is readily available when a handoff command is given or RLF occurs. After reception of the RRC handover preparation message, the mobile can continue all data and signaling exchanges with the source as before.

In one such aspect, when the source decides to pursue a handover, it can send a Reduced Handover Command message to the mobile, which may only contain a list of preferred target cell identifiers (e.g., a relatively short message). This message can trigger the mobile to execute handover. In case the mobile encounters RLF to the source before receiving the reduced handover command (or a conventional RRC connection reconfiguration message), it has all of the information needed to execute a handover to one of the prepared target cells.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

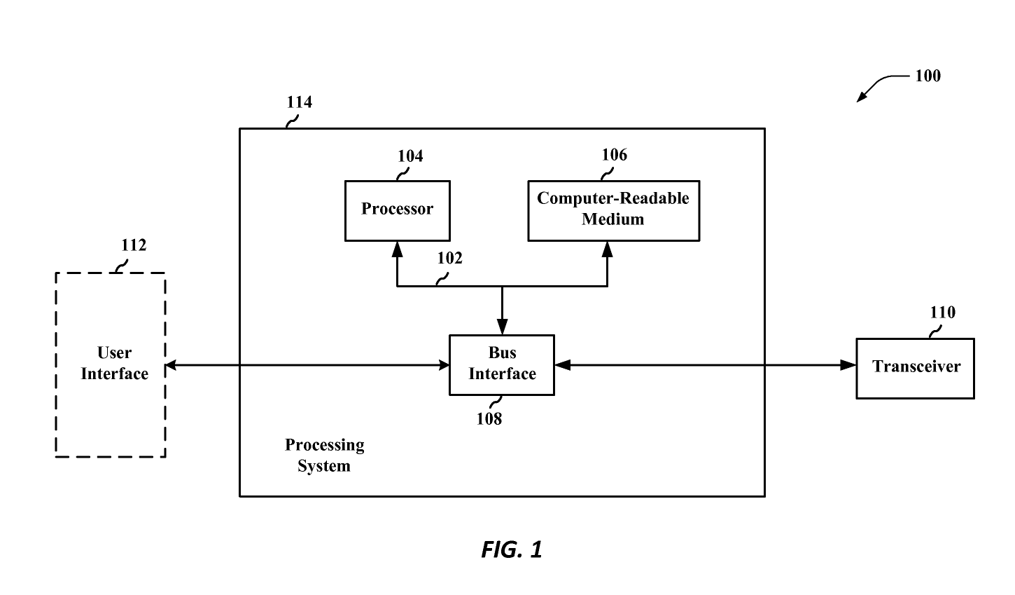

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 104, as utilized in an apparatus 100, may be used to implement any one or more of the processes described below.

In an aspect, the apparatus 100 may be a user equipment (UE) or a base station (BS). The base station may also be referred to by those skilled in the art as a base transceiver station (BTS), a radio base station, a radio transceiver, a transceiver function, a basic service set (BSS), an extended service set (ESS), an access point (AP), a Node B, an eNode B (eNB), mesh node, relay, or some other suitable terminology. A base station may provide wireless access points to a core network for any number of user equipment (UE). Examples of a UE include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, entertainment device, wearable communication device, automobile, mesh network node, M2M component, a game console, or any other similar functioning device. The UE may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology.

The various concepts presented throughout this disclosure may be implemented across a broad variety of telecommunication systems, network architectures, and communication standards. Existing wireless communication networks, such as those defined according to 3GPP standards for the evolved packet system (EPS), frequently referred to as long-term evolution (LTE) networks, provide for handover. However, existing procedures for handling handover are limited and inefficient.

Evolved versions of the LTE network, such as a fifth-generation (5G) network, may provide for many different types of services or applications, including but not limited to web browsing, video streaming, VoIP, mission critical applications, multi-hop networks, remote operations with real-time feedback (e.g., tele-surgery), etc.

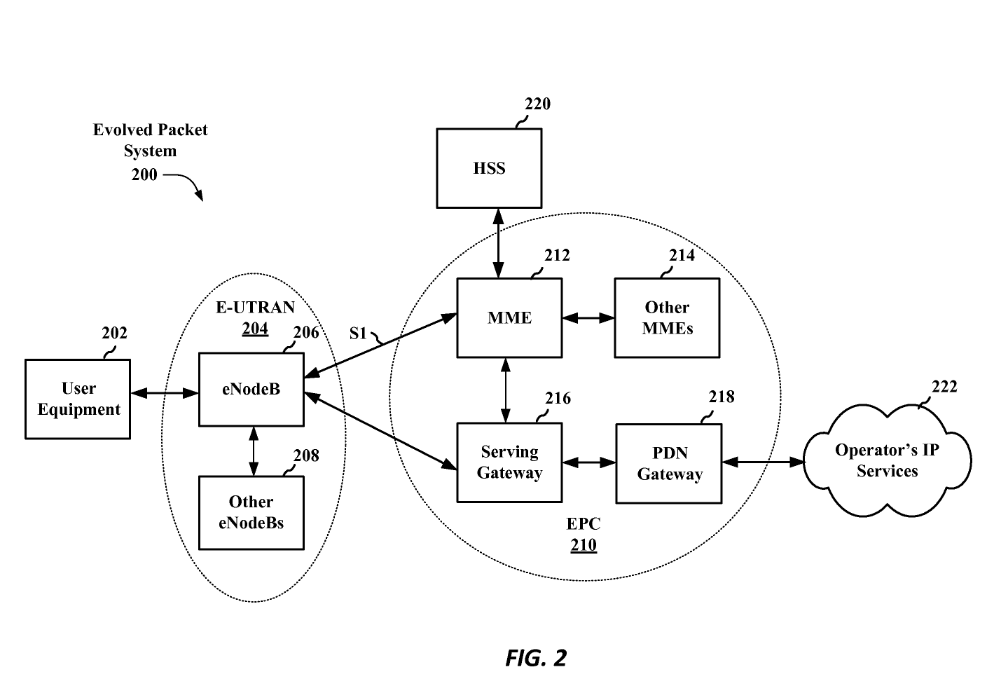

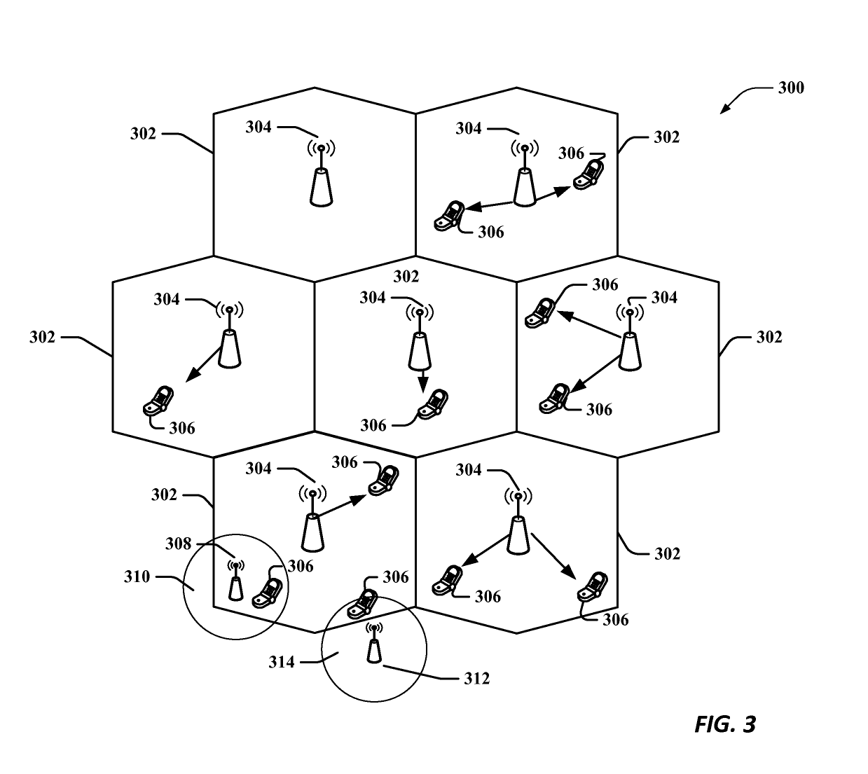

Aspects of the present disclosure are not limited to a particular generation of wireless networks but are generally directed to wireless communication and specifically to LTE and 5G networks. However, to facilitate an understanding of such aspects with a known communication platform, examples of such involving LTE are presented in FIGS. 2-3.

FIG. 2 is a diagram illustrating an LTE network architecture 200 employing various apparatuses 100 (See FIG. 1). The LTE network architecture 200 may be referred to as an Evolved Packet System (EPS) 200. The EPS 200 may include one or more user equipment (UE) 202, an Evolved UMTS Terrestrial Radio Access Network (E-UTRAN) 204, an Evolved Packet Core (EPC) 210, a Home Subscriber Server (HSS) 220, and an Operator's IP Services 222. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 206 and other eNBs 208. The eNB 206 provides user and control plane protocol terminations toward the UE 202. The eNB 206 may be connected to the other eNBs 208 via an X2 interface (i.e., backhaul). The eNB 206 may also be referred to by those skilled in the art as a base station, a base transceiver station, a radio base station, a radio transceiver, a transceiver function, a basic service set (BSS), an extended service set (ESS), or some other suitable terminology. The eNB 206 provides an access point to the EPC 210 for a UE 202. Examples of UEs 202 are described above. The UE 202 may also be referred to by those skilled in the art using other terms such as is described above.

The eNB 206 is connected by an S1 interface to the EPC 210. The EPC 210 includes a Mobility Management Entity (MME) 212, other MMEs 214, a Serving Gateway 216, and a Packet Data Network (PDN) Gateway 218. The MME 212 is the control node that processes the signaling between the UE 202 and the EPC 210. Generally, the MME 212 provides bearer and connection management. All user IP packets are transferred through the Serving Gateway 216, which itself is connected to the PDN Gateway 218. The PDN Gateway 218 provides UE IP address allocation as well as other functions. The PDN Gateway 218 is connected to the Operator's IP Services 222. The Operator's IP Services 222 include the Internet, the Intranet, an IP Multimedia Subsystem (IMS), and a PS Streaming Service (PSS).

FIG. 3 is a diagram illustrating an example of an access network in an LTE network architecture. In this example, the access network 300 is divided into a number of cellular regions (cells) 302. One or more lower power class eNBs 308, 312 may have cellular regions 310, 314, respectively, that overlap with one or more of the cells 302. The lower power class eNBs 308, 312 may be femto cells (e.g., home eNBs (HeNBs)), pico cells, or micro cells. A higher power class or macro eNB 304 is assigned to a cell 302 and is configured to provide an access point to the EPC 210 for all the UEs 306 in the cell 302. There is no centralized controller in this example of an access network 300, but a centralized controller may be used in alternative configurations. The eNB 304 is responsible for all radio related functions including radio bearer control, admission control, mobility control, scheduling, security, and connectivity to the serving gateway 216 (see FIG. 2).

The modulation and multiple access scheme employed by the access network 300 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 304 may have multiple antennas supporting MIMO technology. The use of MIMO technology enables the eNB 304 to exploit the spatial domain to support spatial multiplexing, beamforming, and transmit diversity.

Spatial multiplexing may be used to transmit different streams of data simultaneously on the same frequency. The data steams may be transmitted to a single UE 306 to increase the data rate or to multiple UEs 306 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 306 with different spatial signatures, which enables each of the UE(s) 306 to recover the one or more data streams destined for that UE 306. On the uplink, each UE 306 transmits a spatially precoded data stream, which enables the eNB 304 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PARR). Various frame structures may be used to support the DL and UL transmissions.

The increasing demand for wireless capacity forces network operators to move toward increasingly smaller cell sizes such as Pico cells, which creates highly densified network deployments.

At the same time, allocation of new frequency bands occurs at increasingly higher frequency bands where propagation loss is higher and diffraction less pronounced. Recently, band extensions to the mmWave range have been proposed for cellular operation. This evolution, again, forces cell sizes to become smaller. The reduced diffraction in these higher frequency bands also creates more pronounced shadowing effects.

Smaller cell sizes and pronounced shadowing lead to more frequent handovers and the spatio-temporal handover margin narrows. In response, handover procedures have to be conducted faster and more reliably to avoid impairment to higher protocol layers (3GPP TR 26.839 and TR 36.842).

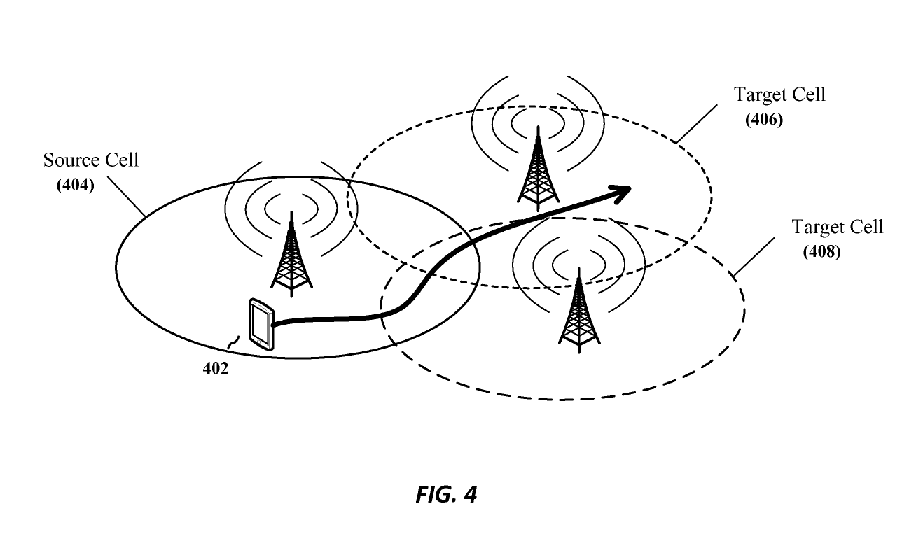

FIG. 4 is a diagram illustrating an example of a typical handover in a cellular system. In one case of operation for FIG. 4, the mobile 402, connected to source cell 404, can identify suitable target cells including a first target cell 406 and a second target cell 408. When the source cell 404 notifies the mobile 402 that a handover is needed, the mobile 402 performs the handover to the first target cell 406. The terms “handover” and “handoff” may be used interchangeably herein with the same intended meaning.

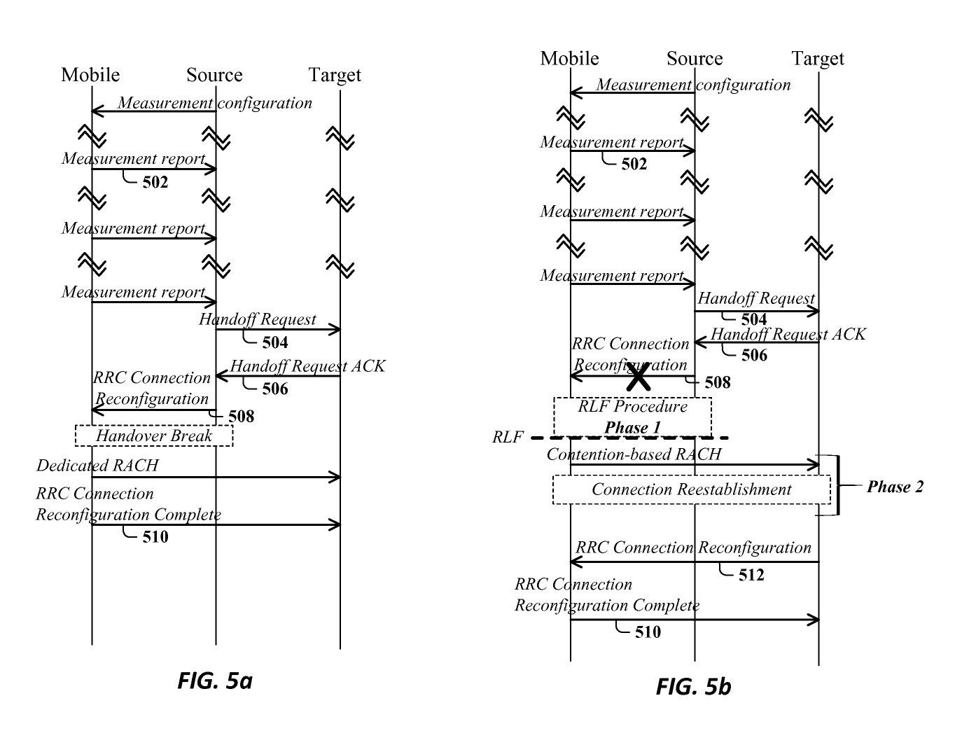

FIGS. 5a and 5b are protocol flow diagrams illustrating typical handover procedures in an LTE system. The present LTE intra-frequency handover procedure is network based and mobile assisted (FIG. 5a). This means that the mobile node, referred to as UE or as a wireless communication device, conducts measurements on potential target cells for handover and reports these measurements (502) to the serving cell (referred to as source cell). Based on these measurements, the source cell decides if handover should be conducted. If this is the case, it prepares the handover by initiating a signaling handshake with the target (e.g., Handoff Request 504), which responds with all necessary information needed for the handover (e.g., Handoff Request ACK 506). The source forwards this information to the UE via the RRC Connection Reconfiguration message 508. Upon successful reception, the UE processes the data, accesses the target cell and sends the RRC Connection Reconfiguration Complete message 510.

For this handover mechanism to succeed, the UE needs sufficient link quality with the source cell until the RRC Connection Reconfiguration message 508 has been received. While this condition typically applies to macro-cellular networks operating at operation frequencies around 1-2 GHz (gigahertz), it becomes increasingly harder to meet for small cell deployments and higher frequency bands.

In case the handover procedure fails, LTE envisions a Radio Link Failure (RLF) recovery procedure (FIG. 5b). This procedure generally consists of two phases, where Phase 1 serves the UE to ascertain failure of the radio link to the source and Phase 2 allows the UE to autonomously access a potential target cell. Upon access, the UE and target cell conduct a handshake to reestablish RRC connectivity. After the RLF recovery procedure, the target cell reconfigures the UE via the RRC Connection Reconfiguration message 512.

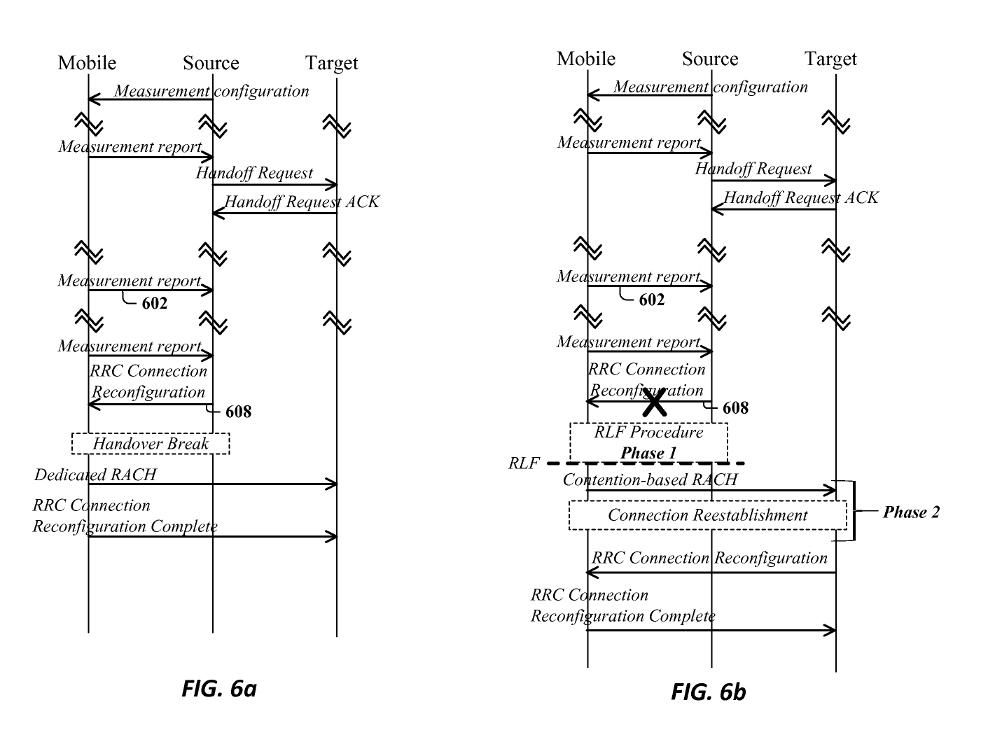

FIGS. 6a and 6b are protocol flow diagrams illustrating alternative handover procedures in an LTE system. More specifically, FIG. 6a illustrates a network based handover when no RLF occurs with the source cell. In such case, the source may prepare the target but waits to receive more measurement reports 602 before sending the RRC Connection Reconfiguration message 608. FIG. 6b illustrates a similar situation where RLF occurs with the source and UE based handover is conducted involving the LTE recovery procedure.

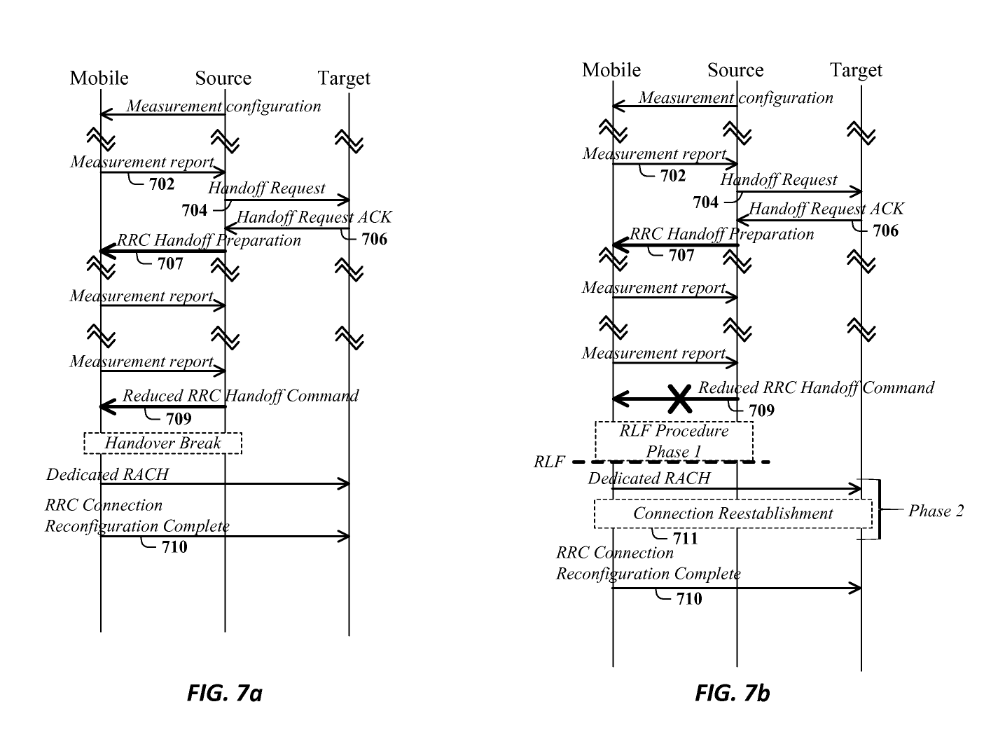

Undergoing recovery from RLF is faced with two principle obstacles. Firstly, RRC connection re-establishment only works if the target cell has been prepared by the source cell before. Presently (e.g., in systems known in the art), the UE does not know if and which potential target cell has been prepared. In case it selects an unprepared target, the UE has to return to idle state. The source can reduce the likelihood of such events by preemptively preparing many target cells before handover is imminent. FIGS. 7a and 7b are protocol flow diagrams illustrating exemplary handover procedures with preemptive preparation in an LTE system, and will be discussed in greater detail below.

Secondly, access to a (prepared) target cell after RLF consumes more time than the normal handover procedure. One reason for the insertion delay is the UE's lacking information about the target cell. Therefore, the UE conducts contention based access to the target since it hasn't received a dedicated preamble from the target. Further, all of the target's system information has to be forwarded to the UE and processed after accessing the target cell as opposed to a successful non-RLF handover, where processing can occur in parallel to the access procedure.

These two obstacles are not addressed by the current handover procedures available in LTE as illustrated in FIGS. 5a, 5b, 6a, and 6b.

To improve the present handover and RLF recovery procedures a number of changes are proposed.

FIGS. 7a and 7b are protocol flow diagrams illustrating exemplary handover procedures with preemptive preparation and mobile target selection in an LTE system. The source cell may preemptively prepare the mobile node with all of the data needed to access potential target, i.e. before a handover is imminent, and allow the mobile node to select a target for the handover. For this purpose, the source cell may send an RRC Handover Preparation message 707 to the mobile after having received a measurement report 702 and having performed a signaling handshake with the target (704, 706). This message 707 may contain the same target cell information as the RRC Connection Reconfiguration message (see 508 in FIG. 5a). The source cell may obtain this information from the Handover Request ACK message 706 forwarded by the target cell in reply to the source's Handover Request message 704.

The RRC Handover Preparation message 707 may contain the implication for the mobile to cache the information and to process it as necessary so that the processed information is readily available in case a handover command is sent by the source or RLF with the source cell occurs. The RRC Handover Preparation message 707 may further include an explicit indicator which allows the mobile to exercise handover at its own will. Alternatively, the message 707 may include an explicit indicator that prohibits handover unless explicitly authorized via another message by the source or unless RLF has occurred to the source. These indicators may also be provided implicitly, e.g. by the message type or the presence, the absence, or the value of certain message information elements carried in the message.

Upon reception of the RRC Handover Preparation message 707, the mobile may store at least part of the information contained in this message if it has resources available. It may further start processing part of the information at its own will. It may be possible, for instance, to derive a key for the target cell from the material enclosed in the message.

After reception of the RRC Handover Preparation message 707, the mobile may continue exchanging traffic and signaling data with the source cell unless RLF has occurred or unless the RRC Handover Preparation message 707 has permitted the UE to conduct a handover based on its own decision. The mobile may also continue conducting measurements of the source cell and potential target cells and it may report these measurements to the source cell. The mobile may further continue transmission and reception of all other signaling messages to and from the source.

In case the mobile receives a further RRC Handover Preparation message (not shown in FIG. 7a), it may compare (at least part of) the content of this message with information it obtained from prior RRC Handover Preparation messages. In case the new message refers to the same target cell as a prior one, it may overwrite cached information with the values provided in the new message. It may also reprocess some of the data such as the key derivation for the target cell, for instance. In case the message refers to a new target cell, the mobile may cache and process the corresponding data if sufficient resources are available. If sufficient resources are not available, the mobile may overwrite cached information from another target cell with that of the new target cell.

The mobile may further cache such target information together with a time stamp. This allows the mobile to judge the freshness of the information. The mobile may further cache such target information together with measurement data it obtained for this target. This allows the mobile to decide on the best target cell in the RLF recovery procedure or if it has been authorized to execute handover at its own will.

The mobile may further delete such cached information after some time. In this case, it may send an RRC Handover Preparation Deletion message (not shown) to the source cell. This allows the source to redo the handover preparation in case the target is still a potential handover candidate. The time frame for deletion of handover preparation data may be provided in the RRC Handover Preparation message or it may be communicated to the mobile by other means.

The source cell can initiate a handover by sending LTE's present RRC Connection Reconfiguration message or sending a Reduced RRC Handoff Command message 709 in case it prepared the mobile for this target before. The Reduced RRC Handoff Command message 709 may indicate multiple potential target cells from which the mobile may select one or simply notify the mobile to select one of the stored targets for handover. The list of target cells may further be prioritized by the source. Additional information may be included that assists the mobile in selecting a target cell from this list. The message may further contain some updated information on one or more targets.

Upon reception of LTE's present RRC Connection Reconfiguration message (e.g., instead of the Reduced RRC Handoff Command message 709) from the source, the mobile may compare the target provided in the message with the list of prepared targets for which it has data cached or already processed. In case it finds a match and the new information is the same as the prior information for this target, the mobile may save certain processing steps and immediately fetch the processed data. If the mobile observes a mismatch between the new information and the cached information for this target, it may be advised to reprocess the data and rely only on the most recent information.

Upon reception of a Reduced RRC Handoff Command message 709, the mobile may compare the targets specified in the message with the list of targets for which it has data cached and eventually processed. If matches are found, the mobile may retrieve the associated data and conduct a handover to a preferred target in this group. In an aspect, it should update any cached information with fresher information if contained in this message. If multiple targets cells are provided in the message, the mobile may select one of these targets. The mobile may apply prioritization rules embedded in the message during the selection process.

In case the mobile observes RLF to the source cell without having received LTE's present RRC Connection Reestablishment or the proposed Reduced RRC Handoff Command messages, it may select a cell from the list of target cells for which it has information cached. The selection process may be influenced by the amount of data cached for the target cell candidates, the freshness of the data, and the measurements conducted on these cells. The mobile may access the selected target cell using the dedicated preamble, which was forwarded in the RRC Handover Preparation message and which it may retrieve from the cache.

After successful RRC Connection Reestablishment (711), the mobile can directly send LTE's present RRC Connection Reconfiguration Complete message 710 without waiting for the RRC Connection Reconfiguration message from the target cell. This is possible due to the RRC preparation the mobile obtained via the RRC Handover Preparation message.

After successful handover or RRC Connection Reestablishment, the mobile may delete at least some of the cached information for target cells. Eventually, the mobile may flush all of the preemptive handover information from the cache and wait for new RRC Handoff Preparation messages from the new source cell.

In one aspect, the RRC Handoff Preparation message may contain one or more elements of information such as:
Target Physical Cell Identifier (Id);
Carrier Frequency;
Carrier Bandwidth including downlink (DL) bandwidth and uplink (UL) bandwidth;
Additional Spectrum Emissions;
New UE Identifier;
Dedicated Radio Bearer Continue Header Compression;
Common Radio Resource Configuration;
Dedicated RACH configuration;
FDD/TDD field;
Configuration of physical, transport or logical channels;
Configuration of power control, radio link control (RLC), packet data convergence protocol (PDCP);
Antenna configuration;
TDD/FDD configuration;
Cyclic Prefix configuration;
Frame or subframe configuration;
Paging related information;
Signaling bearers to be added, released, modified;
Dedicated bearers to be added, released, modified;
Secondary cells to be added, released, modified;
Neighbor cell lists;
Measurement configuration;
Security information including security algorithms, key-change indicates, next-hop chaining counter, non-access stratum (NAS) security parameters; and/or
Indicator for mobile-initiated handover.

In another aspect, the Reduced RRC Handoff Command message may contain only the following elements of information:
A single Target Physical Cell Id;
A list of Target Physical Cell Ids;
A flag indicating that the mobile can handover to a preconfigured cell; and/or
Any subset of data contained in the RRC Handoff Preparation message.

While the concepts of FIGS. 7a and 7b are discussed above in the context of LTE, they can also apply to other wireless technologies, including those involving mmWave or others in need of fast handover.

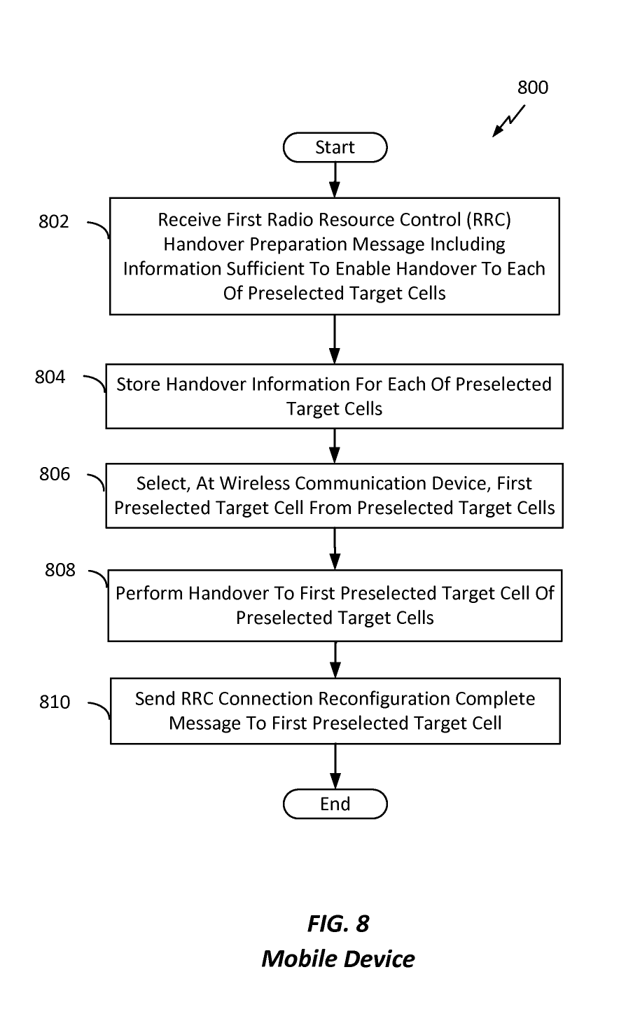

FIG. 8 is a flow chart illustrating an exemplary process 800 for operating a mobile device involved in a handover procedure with preemptive preparation and mobile target selection in accordance with some aspects of the disclosure. In one aspect, the process 800 can be used by the mobile device of FIGS. 7a and 7b. In block 802, the process receives a first radio resource control (RRC) handover preparation message (e.g., from the source cell) including information sufficient to enable a handover to each of a plurality of preselected target cells (e.g., see information described above that may be contained in a RRC handoff preparation message). In one aspect, the process also receives a measurement configuration message from a source cell, measures a plurality of target cells in response to the measurement configuration message, and sends a measurement report including the measurements of the plurality of target cells to the source cell prior to receiving the RRC handover preparation message. In block 804, the process stores the handover information for each of the plurality of preselected target cells (e.g., in a cache or other suitable memory).

In block 806, the process selects, at the wireless communication device, a first preselected target cell from the plurality of preselected target cells. In an aspect, the selection of the first preselected target cell for the handover may be guided by the source cell. In such case, the process may receive a reduced RRC handover command message or an RRC connection reconfiguration message (e.g., from the source cell) prior to the handover where the messages may include a prioritized list of the potential target cells. In one aspect, the process does not receive the reduced RRC handover command message or the RRC connection reconfiguration message prior to the handover and instead detects a radio link failure (RLF). In such case, the process (e.g., mobile device or wireless communication device) can select the preselected target cell based on the stored handover information for the preselected target cells. In several aspects, the mobile device selects the first preselected target cell for the handover. In one such case, the mobile device selects the first preselected target cell for the handover after detecting the RLF. In another such case, the mobile device selects the first preselected target cell for the handover based on a recommendation from the source cell (e.g., a prioritized list or other recommendation). In one aspect, the target selection can be based, in whole or in part, on by the amount of data cached for the target cell candidates, the freshness of the data, and the measurements conducted on these cells.

In block 808, the process performs a handover to the first preselected target cell of the plurality of preselected target cells. In block 810, the process sends an RRC connection reconfiguration complete message to the first preselected target cell.

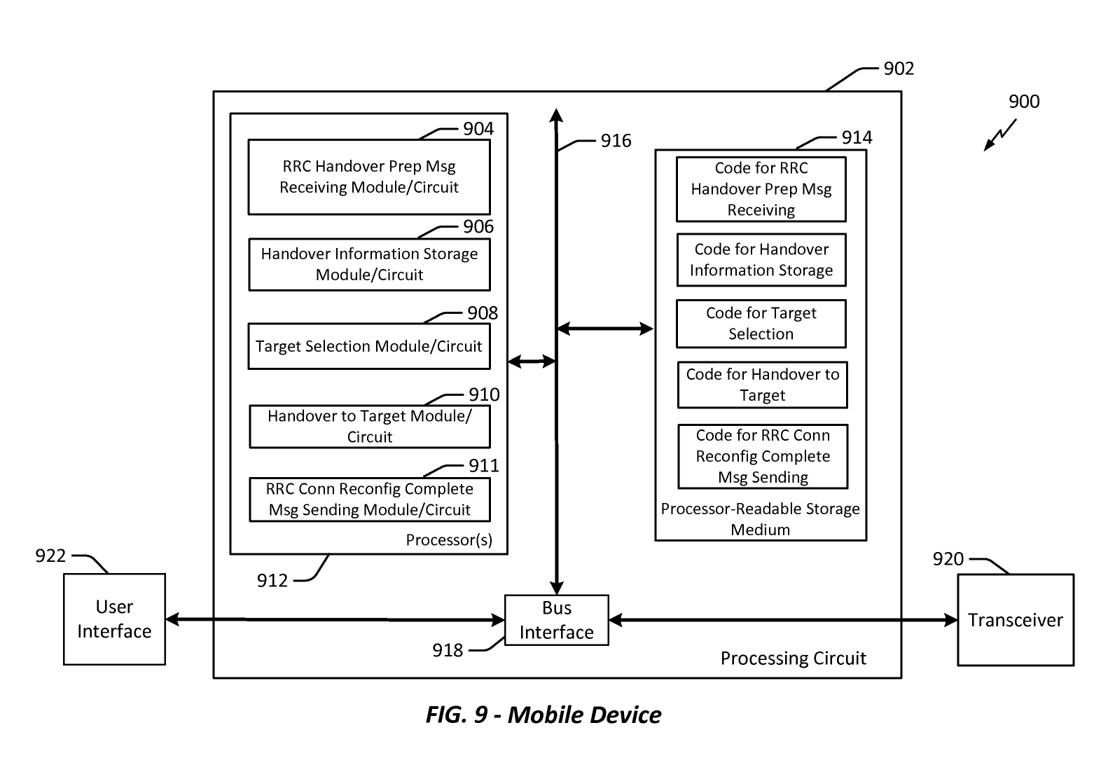

FIG. 9 is a diagram illustrating a simplified example of a hardware implementation for an apparatus employing a processing circuit and adapted for operating a mobile device involved in a handover procedure with preemptive preparation and mobile target selection in accordance with some aspects of the disclosure. The processing circuit 902 may be provided in accordance with certain aspects illustrated in relation to the processing system 114 of FIG. 1. The processing circuit 902 has one or more processors 912 that may include a microprocessor, microcontroller, digital signal processor, a sequencer and/or a state machine. The processing circuit 902 may be implemented with a bus architecture, represented generally by the bus 916.

The bus 916 may include any number of interconnecting buses and bridges depending on the specific application of the processing circuit 902 and the overall design constraints. The bus 916 links together various circuits including a computer-readable storage medium 914 and the one or more processors 912 and/or hardware devices that cooperate to perform certain functions described herein, and which are represented by the modules and/or circuits 904, 906, 908, 910, and 911. The bus 916 may also link various other circuits such as timing sources, timers, peripherals, voltage regulators, and power management circuits. A bus interface 918 may provide an interface between the bus 916 and other devices such as a transceiver 920 or a user interface 922. The transceiver 920 may provide a wireless communications link for communicating with various other apparatus. In some instances the transceiver 920 and/or user interface 922 may connect directly to the bus 916.

The processor 912 is responsible for general processing, including the execution of software stored as code on the computer-readable storage medium 914. The software, when executed by the processor 912, configures one or more components of the processing circuit 902 such that the processing circuit 902 may perform the various functions described above for any particular apparatus. The computer-readable storage medium 914 may also be used for storing data that is manipulated by the processor 912 when executing software. The processing circuit 902 further includes at least one of the modules 904, 906, 908, 910, and 911. The modules 904, 906, 908, 910, and 911 may be software modules running in the processor 912 loaded from code resident and/or stored in the computer readable storage medium 914, one or more hardware modules coupled to the processor 912, or some combination thereof. The modules 904, 906, 908, 910 and/or 911 may include microcontroller instructions, state machine configuration parameters, or some combination thereof.

Module and/or circuit 904 may be configured to receive a first radio resource control (RRC) handover preparation message (e.g., from the source cell) including information sufficient to enable a handover to each of a plurality of preselected target cells (e.g., see information described above that may be contained in a RRC handoff preparation message). In one aspect, the module and/or circuit 904 may be configured to perform the functions described in relation to block 802 in FIG. 8, or other functions associated with FIG. 8.

Module and/or circuit 906 may be configured to store the handover information for each of the plurality of preselected target cells (e.g., in a cache or other suitable memory). In one aspect, the module and/or circuit 906 may be configured to perform the functions described in relation to block 804 in FIG. 8, or other functions associated with FIG. 8.

Module and/or circuit 908 may be configured to select, at the wireless communication device, a first preselected target cell from the plurality of preselected target cells. In one aspect, the module and/or circuit 908 may be configured to perform the functions described in relation to block 806 in FIG. 8, or other functions associated with FIG. 8.

Module and/or circuit 910 may be configured to perform a handover to the first preselected target cell of the plurality of preselected target cells. In one aspect, the module and/or circuit 910 may be configured to perform the functions described in relation to block 808 in FIG. 8, or other functions associated with FIG. 8.

Module and/or circuit 911 may be configured to send an RRC connection reconfiguration complete message to the first preselected target cell. In one aspect, the module and/or circuit 911 may be configured to perform the functions described in relation to block 810 in FIG. 8, or other functions associated with FIG. 8.

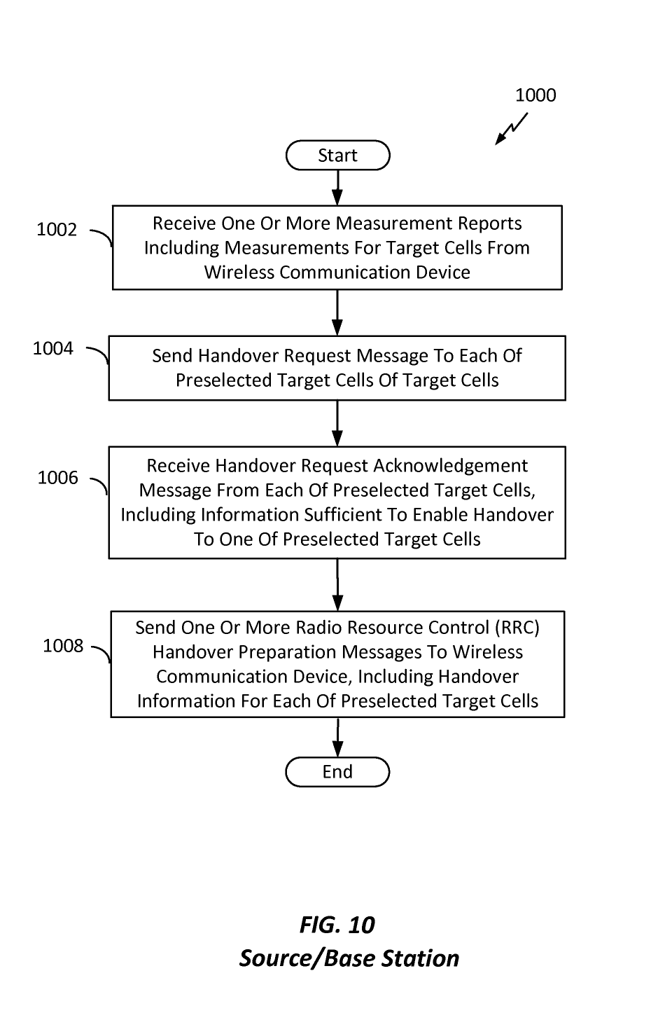

FIG. 10 is a flow chart illustrating an exemplary process 1000 for operating a source cell involved in a handover procedure with preemptive preparation and mobile target selection in accordance with some aspects of the disclosure. In one aspect, the process 1000 can be used by the source cell (e.g., base station) of FIGS. 7a and 7b. In block 1002, the process receives one or more measurement reports including measurements for a plurality of target cells from a wireless communication device (e.g., mobile device). In one aspect the process sends a measurement configuration message to the wireless communication device prior to receiving the measurement report.

In block 1004, the process sends a handover request message to each of a plurality of preselected target cells of the plurality of target cells.

In block 1006, the process receives a handover request acknowledgement message from each of the plurality of preselected target cells, where the handover request acknowledgement message includes information sufficient to enable a handover to one of the plurality of preselected target cells.

In block 1008, the process sends one or more radio resource control (RRC) handover preparation messages to the wireless communication device, where the RRC handover preparation message includes handover information for each of the plurality of preselected target cells. In one aspect, the RRC handover preparation message includes a prioritized list of the plurality of preselected target cells.

In one aspect, the process also sends a reduced RRC handover command message or an RRC connection reconfiguration message to the wireless communication device, where the reduced RRC handover command message includes updated handover information for at least one of the preselected target cells. In one aspect, the reduced RRC handover command message simply includes instructions for handover to be performed by the mobile device as soon as possible or within a preselected duration.

In one aspect, the process receives, in block 1002, a single measurement report including measurements for a plurality of target cells from a wireless communication device (e.g., mobile device). In one such case, the process may send, in block 1004, a handover request message to just one preselected target cell (e.g., first preselected target cell) of the plurality of target cells. In such case, the process sends, in block 1008, the RRC handover preparation message to the wireless communication device, where the RRC handover preparation message includes handover information for just the first preselected target cell. In one aspect, the actions described above in this paragraph may be repeated such that the wireless device is prepared with the handover information for a plurality of target cells using multiple handover preparation messages.

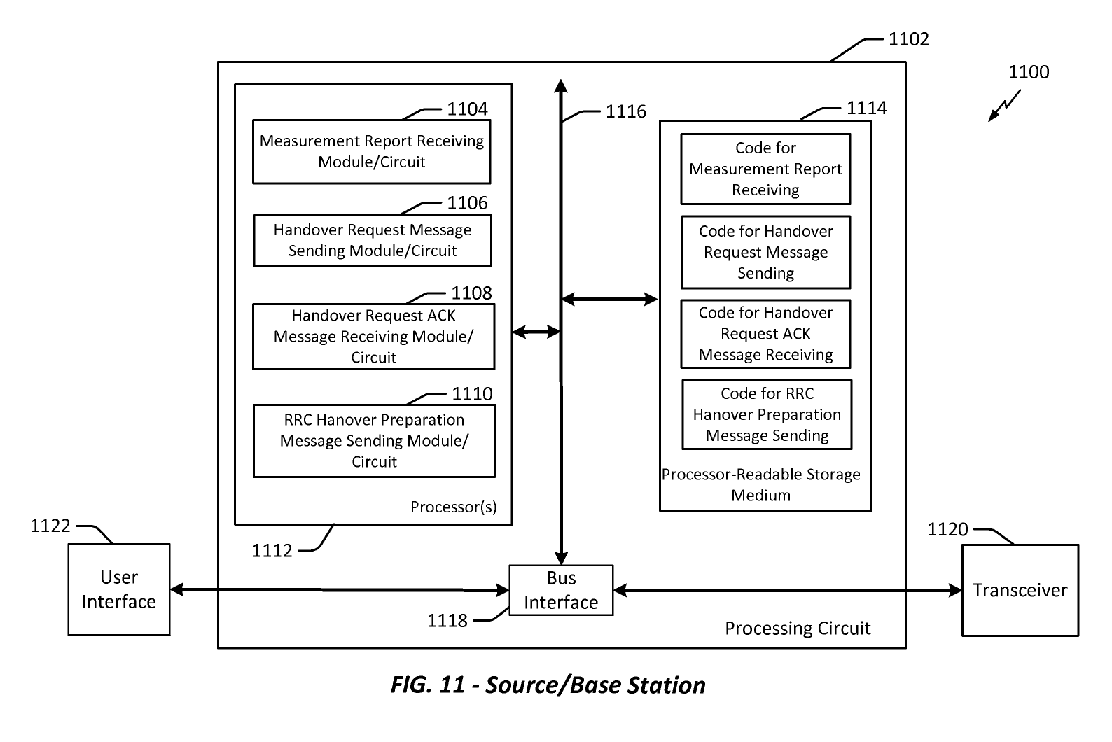

FIG. 11 is a diagram illustrating a simplified example of a hardware implementation for an apparatus employing a processing circuit and adapted for operating a source cell involved in a handover procedure with preemptive preparation and mobile target selection in accordance with some aspects of the disclosure.

The processing circuit 1102 may be provided in accordance with certain aspects illustrated in relation to the processing system 114 of FIG. 1. The processing circuit 1102 has one or more processors 1112 that may include a microprocessor, microcontroller, digital signal processor, a sequencer and/or a state machine. The processing circuit 1102 may be implemented with a bus architecture, represented generally by the bus 1116.

The bus 1116 may include any number of interconnecting buses and bridges depending on the specific application of the processing circuit 1102 and the overall design constraints. The bus 1116 links together various circuits including a computer-readable storage medium 1114 and the one or more processors 1112 and/or hardware devices that cooperate to perform certain functions described herein, and which are represented by the modules and/or circuits 1104, 1106, 1108, and 1110. The bus 1116 may also link various other circuits such as timing sources, timers, peripherals, voltage regulators, and power management circuits. A bus interface 1118 may provide an interface between the bus 1116 and other devices such as a transceiver 1120 or a user interface 1122. The transceiver 1120 may provide a wireless communications link for communicating with various other apparatus. In some instances the transceiver 1120 and/or user interface 1122 may connect directly to the bus 1116.

The processor 1112 is responsible for general processing, including the execution of software stored as code on the computer-readable storage medium 1114. The software, when executed by the processor 1112, configures one or more components of the processing circuit 1102 such that the processing circuit 1102 may perform the various functions described above for any particular apparatus. The computer-readable storage medium 1114 may also be used for storing data that is manipulated by the processor 1112 when executing software. The processing circuit 1102 further includes at least one of the modules 1104, 1106, 1108, and 1110. The modules 1104, 1106, 1108, and 1110 may be software modules running in the processor 1112 loaded from code resident and/or stored in the computer readable storage medium 1114, one or more hardware modules coupled to the processor 1112, or some combination thereof. The modules 1104, 1106, 1108, and/or 1110 may include microcontroller instructions, state machine configuration parameters, or some combination thereof.

Module and/or circuit 1104 may be configured to receive a measurement report including measurements for a plurality of target cells from a wireless communication device. In one aspect, the module and/or circuit 1104 may be configured to perform the functions described in relation to block 1002 in FIG. 10, or other functions associated with FIG. 10.

Module and/or circuit 1106 may be configured to send a handover request message to each of a plurality of preselected target cells of the plurality of target cells. In one aspect, the module and/or circuit 1106 may be configured to perform the functions described in relation to block 1004 in FIG. 10, or other functions associated with FIG. 10.

Module and/or circuit 1108 may be configured to receive a handover request acknowledgement message from each of the plurality of preselected target cells, where the handover request acknowledgement message includes information sufficient to enable a handover to one of the plurality of preselected target cells. In one aspect, the module and/or circuit 1108 may be configured to perform the functions described in relation to block 1006 in FIG. 10, or other functions associated with FIG. 10.

Module and/or circuit 1110 may be configured to send a radio resource control (RRC) handover preparation message to the wireless communication device, where the RRC handover preparation message includes handover information for each of the plurality of preselected target cells. In one aspect, the module and/or circuit 1110 may be configured to perform the functions described in relation to block 1008 in FIG. 10, or other functions associated with FIG. 10.

Aspects of the methods and apparatuses described herein apply to handover in cellular access technologies like LTE. Aspects of the methods and apparatuses described herein can be specifically suitable for mmWave-based access technologies, where handover has to be executed fast due to shadowing effects, which may cause sudden Radio Link Failure (RLF) between mobile and serving base station.

It is expected that 3GPP will support new radio access technologies like mmWaves in the future. For such technologies, it is very likely that the present LTE-based handover procedure will be adopted. The modifications as proposed in this document will therefore be of benefit for present as well as for future radio access technologies.

Aspects of the method and apparatus described herein involve preemptive preparation of a mobile device for handover, which can provide a number of advantages. As to the first advantage, handover decisions may remain network controlled unless RLF occurs. The proposed procedure is therefore in line with typical 3GPP mobility procedures and can be expected to find easy acceptance.

As to the second advantage, the preemptive transfer of handover related information is more reliable when conducted while the link between source and mobile is still strong. This is not the case for the present RRC Connection Reconfiguration message which has to be sent, when handover is imminent, i.e. when the link between source and mobile is typically weak.

As to the third advantage, preemptive preparation of the mobile allows the source cell to use a Reduced Handover Command message to actually trigger the handover. Due to its small size, the likelihood for this message to encounter an error during transmission is therefore much smaller.

As to the fourth advantage, the RRC Handover Preparation message allows the mobile to pre-process and cache some of the information such as system information and key derivation prior to handover or RLF. This preprocessing may speed up handover or RLF recovery procedure in case they occur.

As to the fifth advantage, the RRC Handover Preparation message informs the UE which target cells have been prepared by the source. In an aspect, this enables the mobile to select a prepared target cell during RLF-Recovery and consequently for the consecutive RRC Connection Reestablishment procedure to succeed.

As to the sixth advantage, the RRC Handover Preparation message further furnishes the mobile with the target cell's dedicated RACH preamble which permits non-contentious access from the RLF recovery procedure. This is generally faster than contention based access currently used in the RLF recovery procedure.

As to the seventh advantage, after the RLF recovery procedure, the RRC Connection Reconfiguration message from the target cell to the mobile can be omitted. Instead the mobile can directly send the RRC Connection Reconfiguration Complete message.

As those skilled in the art will readily appreciate, various aspects described throughout this disclosure may be extended to any suitable telecommunication systems, network architectures and communication standards. By way of example, various aspects may be applied to UMTS systems such as W-CDMA, TD-SCDMA, and TD-CDMA. Various aspects may also be applied to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems, including those described by yet-to-be defined wide area network standards. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-11 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, where reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication for a wireless communication device, comprising:
receiving a first radio resource control (RRC) handover preparation message comprising information sufficient to enable a handover to each of a plurality of preselected target cells;
storing the handover information for each of the plurality of preselected target cells;
selecting, at the wireless communication device, a first preselected target cell from the plurality of preselected target cells;
performing a handover to the first preselected target cell of the plurality of preselected target cells; and
sending an RRC connection reconfiguration complete message to the first preselected target cell.

2. The method of claim 1, further comprising:
receiving a reduced RRC handover command message or an RRC connection reconfiguration message; and
wherein the selecting, at the wireless communication device, the first preselected target cell from the plurality of preselected target cells comprises selecting, at the wireless communication device and based on information contained in the reduced RRC handover command message or the RRC connection reconfiguration message, the first preselected target cell from the plurality of preselected target cells.

3. The method of claim 1, further comprising:
detecting a radio link failure (RLF) to a source cell previously providing wireless connectivity to the wireless communication device; and
wherein the selecting, at the wireless communication device, the first preselected target cell from the plurality of preselected target cells comprises selecting, at the wireless communication device and based on the RLF and the stored handover information for each of the plurality of preselected target cells, the first preselected target cell from the plurality of preselected target cells.

4. The method of claim 3:
wherein the selecting, at the wireless communication device and based on the RLF and the stored handover information for each of the plurality of preselected target cells, the first preselected target cell is based on a factor selected from the group consisting of an amount of data stored for each of the plurality of preselected target cells, a freshness of the data stored for each of the plurality of preselected target cells, measurements conducted on each of the plurality of preselected target cells, and combinations thereof.

5. The method of claim 1, further comprising:
measuring a plurality of target cells in response to the first RRC handover preparation message.

6. The method of claim 1, further comprising:
receiving a second RRC handover preparation message comprising information sufficient to enable a handover to each of a plurality of second preselected target cells;
comparing the handover information from the second RRC handover preparation message with the handover information from the first RRC handover preparation message;
updating, if there is a common target cell between the handover information from the second RRC handover preparation message and the handover information from the first RRC handover preparation message, the stored handover information for the common target cell; and
storing, if a given target cell of the handover information from the second RRC handover preparation message is not found in the handover information from the first RRC handover preparation message, the handover information for the given target cell.

7. The method of claim 1:
wherein the first RRC handover preparation message comprises a preselected duration;
the method further comprising:
deleting, after the preselected duration, the handover information from the first RRC handover preparation message; and
sending an RRC handover preparation deletion message to a source cell of the wireless communication device.

8. The method of claim 1, further comprising:
receiving a reduced RRC handover command message comprising a prioritized list of the plurality of preselected target cells; and
wherein the selecting, at the wireless communication device, the first preselected target cell from the plurality of preselected target cells comprises selecting, at the wireless communication device and based on the prioritized list of the plurality of preselected target cells, the first preselected target cell from the plurality of preselected target cells.

9. The method of claim 1, further comprising:
receiving a reduced RRC handover command message comprising information sufficient to enable a handover to a preselected target cell; and
comparing the handover information from the reduced RRC handover command message to the stored handover information from the first RRC handover preparation message for a match.

10. The method of claim 1, further comprising:
receiving a reduced RRC handover command message comprising information sufficient to enable a handover to a plurality of select target cells; and
wherein the selecting, at the wireless communication device, the first preselected target cell from the plurality of preselected target cells comprises selecting, at the wireless communication device and based on the information contained in the reduced RRC handover command message, the first preselected target cell from the plurality of select target cells.

11. The method of claim 1, further comprising:
sending the RRC connection reconfiguration complete message without having received an RRC connection reconfiguration message.

12. A wireless communication device, comprising:
means for receiving a first radio resource control (RRC) handover preparation message comprising information sufficient to enable a handover to each of a plurality of preselected target cells;
means for storing the handover information for each of the plurality of preselected target cells;
means for selecting, at the wireless communication device, a first preselected target cell from the plurality of preselected target cells;
means for performing a handover to the first preselected target cell of the plurality of preselected target cells; and
means for sending an RRC connection reconfiguration complete message to the first preselected target cell.

13. The wireless communication device of claim 12, further comprising:
means for receiving a reduced RRC handover command message or an RRC connection reconfiguration message; and
wherein the means for selecting, at the wireless communication device, the first preselected target cell from the plurality of preselected target cells comprises means for selecting, at the wireless communication device and based on information contained in the reduced RRC handover command message or the RRC connection reconfiguration message, the first preselected target cell from the plurality of preselected target cells.

14. The wireless communication device of claim 12, further comprising:
means for detecting a radio link failure (RLF) to a source cell previously providing wireless connectivity to the wireless communication device; and
wherein the means for selecting, at the wireless communication device, the first preselected target cell from the plurality of preselected target cells comprises means for selecting, at the wireless communication device and based on the RLF and the stored handover information for each of the plurality of preselected target cells, the first preselected target cell from the plurality of preselected target cells.

15. The wireless communication device of claim 14:
wherein the means for selecting, at the wireless communication device and based on the RLF and the stored handover information for each of the plurality of preselected target cells, the first preselected target cell is based on a factor selected from the group consisting of an amount of data stored for each of the plurality of preselected target cells, a freshness of the data stored for each of the plurality of preselected target cells, measurements conducted on each of the plurality of preselected target cells, and combinations thereof.

16. The wireless communication device of claim 12, further comprising:
means for measuring a plurality of target cells in response to the first RRC handover preparation message.

17. The wireless communication device of claim 12, further comprising:
means for receiving a second RRC handover preparation message comprising information sufficient to enable a handover to each of a plurality of second preselected target cells;
means for comparing the handover information from the second RRC handover preparation message with the handover information from the first RRC handover preparation message;
means for updating, if there is a common target cell between the handover information from the second RRC handover preparation message and the handover information from the first RRC handover preparation message, the stored handover information for the common target cell; and
means for storing, if a given target cell of the handover information from the second RRC handover preparation message is not found in the handover information from the first RRC handover preparation message, the handover information for the given target cell.

18. The wireless communication device of claim 12:
wherein the first RRC handover preparation message comprises a preselected duration;
the wireless communication device further comprising:
means for deleting, after the preselected duration, the handover information from the first RRC handover preparation message; and
means for sending an RRC handover preparation deletion message to a source cell of the wireless communication device.

19. The wireless communication device of claim 12, further comprising:
means for receiving a reduced RRC handover command message comprising a prioritized list of the plurality of preselected target cells; and
wherein the means for selecting, at the wireless communication device, the first preselected target cell from the plurality of preselected target cells comprises means for selecting, at the wireless communication device and based on the prioritized list of the plurality of preselected target cells, the first preselected target cell from the plurality of preselected target cells.

20. The wireless communication device of claim 12, further comprising:
means for receiving a reduced RRC handover command message comprising information sufficient to enable a handover to a preselected target cell; and
means for comparing the handover information from the reduced RRC handover command message to the stored handover information from the first RRC handover preparation message for a match.

21. The wireless communication device of claim 12, further comprising:
means for receiving a reduced RRC handover command message comprising information sufficient to enable a handover to a plurality of select target cells; and
wherein the means for selecting, at the wireless communication device, the first preselected target cell from the plurality of preselected target cells comprises means for selecting, at the wireless communication device and based on the information contained in the reduced RRC handover command message, the first preselected target cell from the plurality of select target cells.

22. The wireless communication device of claim 12, further comprising:
means for sending the RRC connection reconfiguration complete message without having received an RRC connection reconfiguration message.

23. A wireless communication device, comprising:
at least one processor;
a memory communicatively coupled to the at least one processor; and
a communication interface communicatively coupled to the at least one processor, wherein the at least one processor is configured to:
receive a first radio resource control (RRC) handover preparation message comprising information sufficient to enable a handover to each of a plurality of preselected target cells;
store the handover information for each of the plurality of preselected target cells;
select, at the wireless communication device, a first preselected target cell from the plurality of preselected target cells;
perform a handover to the first preselected target cell of the plurality of preselected target cells; and
send an RRC connection reconfiguration complete message to the first preselected target cell.

24. The wireless communication device of claim 23, wherein the at least one processor is further configured to:
receive a reduced RRC handover command message or an RRC connection reconfiguration message; and
select, at the wireless communication device and based on information contained in the reduced RRC handover command message or the RRC connection reconfiguration message, the first preselected target cell from the plurality of preselected target cells.

25. The wireless communication device of claim 23, wherein the at least one processor is further configured to:
detect a radio link failure (RLF) to a source cell previously providing wireless connectivity to the wireless communication device; and
select, at the wireless communication device and based on the RLF and the stored handover information for each of the plurality of preselected target cells, the first preselected target cell from the plurality of preselected target cells.

26. The wireless communication device of claim 25, wherein the at least one processor is further configured to:
select, at the wireless communication device and based on the RLF and the stored handover information for each of the plurality of preselected target cells, the first preselected target cell based on a factor selected from the group consisting of an amount of data stored for each of the plurality of preselected target cells, a freshness of the data stored for each of the plurality of preselected target cells, measurements conducted on each of the plurality of preselected target cells, and combinations thereof.

27. The wireless communication device of claim 23, wherein the at least one processor is further configured to:
measure a plurality of target cells in response to the first RRC handover preparation message.

28. The wireless communication device of claim 23, wherein the at least one processor is further configured to:
receive a second RRC handover preparation message comprising information sufficient to enable a handover to each of a plurality of second preselected target cells;
compare the handover information from the second RRC handover preparation message with the handover information from the first RRC handover preparation message;
update, if there is a common target cell between the handover information from the second RRC handover preparation message and the handover information from the first RRC handover preparation message, the stored handover information for the common target cell; and
store, if a given target cell of the handover information from the second RRC handover preparation message is not found in the handover information from the first RRC handover preparation message, the handover information for the given target cell.

29. The wireless communication device of claim 23:
wherein the first RRC handover preparation message comprises a preselected duration;
wherein the at least one processor is further configured to:
delete, after the preselected duration, the handover information from the first RRC handover preparation message; and
send an RRC handover preparation deletion message to a source cell of the wireless communication device.

30. The wireless communication device of claim 23, wherein the at least one processor is further configured to:
receive a reduced RRC handover command message comprising a prioritized list of the plurality of preselected target cells; and
select, at the wireless communication device and based on the prioritized list of the plurality of preselected target cells, the first preselected target cell from the plurality of preselected target cells.

31. The wireless communication device of claim 23, wherein the at least one processor is further configured to:
receive a reduced RRC handover command message comprising information sufficient to enable a handover to a preselected target cell; and
compare the handover information from the reduced RRC handover command message to the stored handover information from the first RRC handover preparation message for a match.

32. The wireless communication device of claim 23, wherein the at least one processor is further configured to:
receive a reduced RRC handover command message comprising information sufficient to enable a handover to a plurality of select target cells; and
select, at the wireless communication device and based on the information contained in the reduced RRC handover command message, the first preselected target cell from the plurality of select target cells.

33. The wireless communication device of claim 23, wherein the at least one processor is further configured to:
send the RRC connection reconfiguration complete message without having received an RRC connection reconfiguration message.

34. A non-transitory computer readable medium storing computer executable code, comprising code for:
receiving a first radio resource control (RRC) handover preparation message comprising information sufficient to enable a handover to each of a plurality of preselected target cells;
storing the handover information for each of the plurality of preselected target cells;
selecting, at a wireless communication device, a first preselected target cell from the plurality of preselected target cells;
performing a handover to the first preselected target cell of the plurality of preselected target cells; and
sending an RRC connection reconfiguration complete message to the first preselected target cell.

35. The computer readable medium of claim 34 comprising further code for:
receiving a reduced RRC handover command message or an RRC connection reconfiguration message; and
selecting, at the wireless communication device and based on information contained in the reduced RRC handover command message or the RRC connection reconfiguration message, the first preselected target cell from the plurality of preselected target cells.

36. The computer readable medium of claim 34 comprising further code for:
detecting a radio link failure (RLF) to a source cell previously providing wireless connectivity to the wireless communication device; and
selecting, at the wireless communication device and based on the RLF and the stored handover information for each of the plurality of preselected target cells, the first preselected target cell from the plurality of preselected target cells.

37. The computer readable medium of claim 36 comprising further code for:
selecting, at the wireless communication device and based on the RLF and the stored handover information for each of the plurality of preselected target cells, the first preselected target cell based on a factor selected from the group consisting of an amount of data stored for each of the plurality of preselected target cells, a freshness of the data stored for each of the plurality of preselected target cells, measurements conducted on each of the plurality of preselected target cells, and combinations thereof.

38. The computer readable medium of claim 34 comprising further code for:
measuring a plurality of target cells in response to the first RRC handover preparation message.

39. The computer readable medium of claim 34 comprising further code for:
receiving a second RRC handover preparation message comprising information sufficient to enable a handover to each of a plurality of second preselected target cells;
comparing the handover information from the second RRC handover preparation message with the handover information from the first RRC handover preparation message;
updating, if there is a common target cell between the handover information from the second RRC handover preparation message and the handover information from the first RRC handover preparation message, the stored handover information for the common target cell; and
storing, if a given target cell of the handover information from the second RRC handover preparation message is not found in the handover information from the first RRC handover preparation message, the handover information for the given target cell.

40. The computer readable medium of claim 34:
wherein the first RRC handover preparation message comprises a preselected duration;
the computer readable medium of claim 34, comprising further code for:
deleting, after the preselected duration, the handover information from the first RRC handover preparation message; and
sending an RRC handover preparation deletion message to a source cell of the wireless communication device.

41. The computer readable medium of claim 34 comprising further code for:
receiving a reduced RRC handover command message comprising a prioritized list of the plurality of preselected target cells; and
selecting, at the wireless communication device and based on the prioritized list of the plurality of preselected target cells, the first preselected target cell from the plurality of preselected target cells.

42. The computer readable medium of claim 34 comprising further code for:
receiving a reduced RRC handover command message comprising information sufficient to enable a handover to a preselected target cell; and
comparing the handover information from the reduced RRC handover command message to the stored handover information from the first RRC handover preparation message for a match.

43. The computer readable medium of claim 34 comprising further code for:
receiving a reduced RRC handover command message comprising information sufficient to enable a handover to a plurality of select target cells; and
selecting, at the wireless communication device and based on the information contained in the reduced RRC handover command message, the first preselected target cell from the plurality of select target cells.

44. The computer readable medium of claim 34 comprising further code for:
sending the RRC connection reconfiguration complete message without having received an RRC connection reconfiguration message.

45. A method of wireless communication, comprising:
receiving at least one measurement report comprising measurements for a plurality of target cells from a wireless communication device;
sending a handover request message to each of a plurality of preselected target cells of the plurality of target cells;
receiving a handover request acknowledgement message from each of the plurality of preselected target cells, comprising information sufficient to enable a handover to one of the plurality of preselected target cells; and
sending at least one radio resource control (RRC) handover preparation message to the wireless communication device, comprising handover information for each of the plurality of preselected target cells.

46. The method of wireless communication of claim 45, further comprising:
sending a reduced RRC handover command message or an RRC connection reconfiguration message to the wireless communication device, the reduced RRC handover command message comprising updated handover information for at least one of the preselected target cells.

47. The method of wireless communication of claim 45, wherein the RRC handover preparation message comprises a prioritized list of the plurality of preselected target cells.

48. A wireless communication device, comprising:
means for receiving at least one measurement report comprising measurements for a plurality of target cells from a second wireless communication device;
means for sending a handover request message to each of a plurality of preselected target cells of the plurality of target cells;
means for receiving a handover request acknowledgement message from each of the plurality of preselected target cells, comprising information sufficient to enable a handover to one of the plurality of preselected target cells; and
means for sending at least one radio resource control (RRC) handover preparation message to the second wireless communication device, comprising handover information for each of the plurality of preselected target cells.

49. The wireless communication device of claim 48, further comprising:
means for sending a reduced RRC handover command message or an RRC connection reconfiguration message to the second wireless communication device, the reduced RRC handover command message comprising updated handover information for at least one of the preselected target cells.

50. The wireless communication device of claim 48, wherein the RRC handover preparation message comprises a prioritized list of the plurality of preselected target cells.

51. A wireless communication device, comprising:
at least one processor;
a memory communicatively coupled to the at least one processor; and
a communication interface communicatively coupled to the at least one processor, wherein the at least one processor is configured to:
receive at least one measurement report comprising measurements for a plurality of target cells from a second wireless communication device;
send a handover request message to each of a plurality of preselected target cells of the plurality of target cells;
receive a handover request acknowledgement message from each of the plurality of preselected target cells, comprising information sufficient to enable a handover to one of the plurality of preselected target cells; and
send at least one radio resource control (RRC) handover preparation message to the second wireless communication device, comprising handover information for each of the plurality of preselected target cells.

52. The wireless communication device of claim 51, wherein the at least one processor is further configured to:
send a reduced RRC handover command message or an RRC connection reconfiguration message to the second wireless communication device, the reduced RRC handover command message comprising updated handover information for at least one of the preselected target cells.

53. The wireless communication device of claim 51, wherein the RRC handover preparation message comprises a prioritized list of the plurality of preselected target cells.

54. A non-transitory computer readable medium storing computer executable code, comprising code for:
receiving at least one measurement report comprising measurements for a plurality of target cells from a wireless communication device;
sending a handover request message to each of a plurality of preselected target cells of the plurality of target cells;
receiving a handover request acknowledgement message from each of the plurality of preselected target cells, comprising information sufficient to enable a handover to one of the plurality of preselected target cells; and
sending at least one radio resource control (RRC) handover preparation message to the wireless communication device, comprising handover information for each of the plurality of preselected target cells.

55. The computer readable medium of claim 54 comprising further code for:
sending a reduced RRC handover command message or an RRC connection reconfiguration message to the wireless communication device, the reduced RRC handover command message comprising updated handover information for at least one of the preselected target cells.

56. The computer readable medium of claim 54, wherein the RRC handover preparation message comprises a prioritized list of the plurality of preselected target cells.
